(19) United States
(12) Patent Application Publication
(10) Pub. No.: US 2025/0118277 A1
(43) Pub. Date: Apr. 10, 2025

(54) TORSIONED PICK

(71) Applicant: Manuel HARARI BLANCO, Sevilla (ES)

(72) Inventor: Manuel HARARI BLANCO, Sevilla (ES)

(21) Appl. No.: 18/254,845

(22) PCT Filed: Apr. 12, 2023
(86) PCT No.: PCT/ES2023/070232

§ 371 Date: May 26, 2023

(51) Int. Cl. G10D 3/173

(52) U.S. Cl. CPC G10D 3/173

(57) ABSTRACT

A torsioned pick for playing stringed instruments that offers control over the attack of the played notes, comprising: a guitar pick body, where the bottom part that is held by musician's fingers is twisted along the pick's longitudinal axis to create a double helicoidal geometry for the musician's index finger and thumb; and where the part of the pick that engages the string is twisted along the pick's longitudinal axis to create a double helicoidal geometry.

### TECHNICAL FIELD

The technical field of the invention is that a plectrum or pick used to play stringed instruments whose geometry is defined by a central surface that follows the shape of two double helicoids with a shared axis of rotation and coincident edge, to which a thickness, that may be constant or variable throughout the length of the plectrum, is applied.

### BACKGROUND ART

Stringed instruments such as guitars, basses, or banjos, are played often with a flat piece of material called “plectrum” or “pick”. These usually have the shape of a teardrop or a triangle with rounded corners and have a thickness that often lies between the 0.4 mm and the 1.5 mm. Picks are held by the index finger and thumb, which are placed on the half of the pick that is furthest away from the sharpest corner. When they are used to play the instrument, the pick makes an initial contact with the string, after which it begins to flex the part of it that is not being harnessed by the fingers of the musician, while the string itself bends because of the force exerted on it through the pick. As the hand of the musician pushes the pick in a motion perpendicular to the string's length, the point of contact between the pick and the string begins to slide down the length of the pick until reaching the end of the pick's tip. After this point, the contact between the pick and the string is broken, the pick is pushed beyond the string, and the string begins to vibrate freely. During this described motion, the musician needs to exert a constant compression on the pick with his fingers to prevent it from slipping away.

The act of playing only one string with a pick is called “plucking”, while the act of plating multiple strings with a single stroke of the pick is called “strumming”. The time that passes between the moment of first contact between the pick and the string and the moment in which the pick releases the string and allows it to vibrate (or “play a note”) is called “attack”. A “short” attack means that the notes played by the musician are heard soon after the pick makes an initial contact. This is a property of picks made with less flexible materials, a shorter length and with thicker thicknesses. A “long” attack means that there is a longer period of time between the initial contact of the string and pick and the release of said contact. This is a property of picks that are made with flexible materials, of larger length and thinner thickness.

Musicians may prefer picks with one type of attack over the other depending on the style of music played. For instance, those who play styles in which a lot of “plucking” is required, such as jazz or metal, may prefer using picks with a shorter attack in order to be able to play their instrument faster, since the time necessary to play each note is reduced. Those who play styles of music that are more focused in “strumming”, such as folk or country, may prefer picks with a long attack. This is because these picks can flex more when pushed against the strings, which may allow for the pick to “slap” the next string in the direction of the strum before making it play a nota and after breaking contact with the previous string, which adds a pleasant “percussive” sound to the execution of the chord.

In addition to the attack, the picks also affect the quality of the sound of the instrument by changing the way in which the strings vibrate.

When a musician plays a note on a stringed instrument, the string vibrates across its length with a given amplitude, creating a pitched sound or “note”. The amplitude of said vibration is zero in the two ends where the string is fixed, which are called “nodes”. At different fractions of its length, other vibrations with higher pitch and smaller amplitude occur. These are called “overtones”, and they are perceived as quieter notes of higher frequencies layered over the main note defined by the string's total vibrating length, or “fundamental note”. Overtones have multiple nodes present across the length of the string. All the nodes of a determined overtone are separated by an equal distance. The distance between nodes of a determined overtone is not the same for different overtones. The ratios between the amplitude of the fundamental note played by the musician and the amplitudes of the overtones are what make each stringed instrument sound differently even when they play the same note.

Picks that are thinner offer a smaller contact area when engaging the strings. This reduced contact leads to a smaller constriction across the length of the string while both are engaged and allows the string to vibrate with less dampening of its overtones. This effect on the instrument's sound is called a “brighter tone”. Thicker picks, on the other hand, tend to lower the volume of the overtones of the string's vibration. This is called a “darker tone”.

Finally, the thickness of the pick also affects its ergonomy and comfort. Since the fingers of the player need to be constantly compressing the pick as the instrument is played, thinner picks require the fingers to exert this compressing force against one another from a closer position. This is uncomfortable since the fingers need to be further away from their resting position while exerting this continuous force. Thicker picks tend to be more comfortable, since the fingers exert this force from a position that is closer to the natural resting position of the hand.

All of these factors force the players to compromise on one or more aspects of their comfort and sound when they decide to use a singular pick.

Accordingly, what is needed is a pick that allows to player to have any desired attack with any desired tone while offering the maximum comfort.

Plectrums can be made by “punching” (manufacturing process with which a “punching press” forces a “punch”, which is a tool with a sharp edge that follows a desired shape, to penetrate through a determined piece of material via shearing and create a hole with the shape of the punch's blade) or via mold injection (process through which a molten plastic is injected into a “mold” comprised of two matching parts with an inner cavity between them with the desired shape of the product, which the molten plastic fills before solidifying and permanently retaining the shape). The materials used are often plastics, which may have different properties.

The applicant is aware of the existence of solutions aimed at solving the same technical problem as the present invention. The application USD 603,449 applies a twist in the middle of the pick, the tip and base being flat; it also twists the pick to reach the strings at an angle of 45° to provide less friction.

Patents U.S. Pat. Nos. 8,664,498 and 7,786,362 seek to “align the pick with the strings” with a twist at the tip only.

Patent application US20180374457 describes a pick with a circular profile, for ergonomic purposes.

American design USD 607,920 describes a pick that has a twist on the lower half, and texture on the upper half for added grip.

Patent application US20220328023 describes a pick that creates an “ergonomic contour” (conical surface) to accommodate the fingers.

Finally, EU design number 008719835-0001 describes a plectrum for stringed instruments, which has an ergonomic character, and which has been improved by the present invention in the following aspects:
a) The twist applied to the part of the pick between the player's index finger and thumb generates a self-centering geometry that significantly reduces the force that must be applied to hold the pick in place when used to play the instrument, helping to relieve the accumulated stress on the joints involved.
b) The twist applied to the part of the pick that contacts the strings increases the stiffness of the pick and allows the player to control the amount of contact time required between the pick and the string until the contact is broken and the string vibrates.
c) By adding a variable that makes the stiffness of the pick independent of its thickness, the musician gains the freedom to use the thickness that suits the tone he wishes to obtain from the pick without having to worry about the effect that thickness has on the response time required between the start of the pick-string contact and the start of the string vibration generated at the end of the contact.

### SUMMARY OF THE INVENTION

An object of the invention is a torsioned pick to provide a plectrum which will reduce the force that the musician needs to exert on the plectrum when playing an instrument as well as the resulting fatigue.

It is a further objective to provide a pick with a non-flat geometry that will allow the player to control the attack of the pick independently from its thickness.

The present invention solves the exerted force problem by providing a three-dimensional geometry that has self-centring properties when engaged by the fingers of the musician. Geometrically, the fingers can be simplified as two cylinders that cross over one another at a determined point over the pick. Therefore, a self-centring geometry may be a double helix, whose thickness may or may not be constant throughout the part of the plectrum where the fingers are engaged.

Advantageously, the effect of such geometry would be that if the musician loosens the grip over the pick without separating their fingers from the pick, or if the pick becomes slippery due to the effect of sweat or other factors, the position that the pick will tend to move to in relation to the fingers is towards the appropriate holding position, instead of away from the fingers.

The present invention solves the problem of the dependence of the tone and attack of the pick on its thickness by twisting the part of the pick that engages the strings into a different double helix shape.

Advantageously, this creates a larger resistance to deformation than a flat shape. This helps to shorten the attack regardless of the pick's thickness without having an effect over the tone and allowing the musician to choose a pick of any tone and attack independently. A lack of torsion in the tip of the pick may also be considered if the musician prefers a longer attack.

Such pick may be manufactured via mould injection, machining, or a combination of a punching process followed by a deformation of the material by bending it under the effect of high temperatures.

Throughout the description and the claims, the word “comprises” and variants thereof are not intended to exclude other technical features, additives, components or steps. To those skilled in the art, other objects, advantages, and features of the invention will be apparent in part from the invention and in part from the practice of the invention. The following examples and drawings are provided by way of illustration and are not intended to restrict the present invention. Furthermore, the invention covers all possible combinations of particular and preferred embodiments indicated herein.

### BRIEF DESCRIPTION OF THE DRAWINGS

The following is a very brief description of a series of drawings which help to better understand the invention, and which relate expressly to an embodiment of said invention, which is illustrated as a non-limiting example thereof.

FIG. 1 is a front view of a pick with a double helicoidal shape in the bottom only.

FIG. 2 is a side view of a pick with a double helicoidal shape in the bottom only.

FIG. 3 is an isometric view of a pick with a double helicoidal shape in the bottom only.

FIG. 4 is a bottom view of a pick with a double helicoidal shape in the bottom only.

FIG. 5 is a front view of a pick with a double helicoidal shape in the tip and in the bottom.

FIG. 6 is a side view of a pick with a double helicoidal shape in the tip and in the bottom.

FIG. 7 is an isometric view of a pick with a double helicoidal shape in the tip and in the bottom.

FIG. 8 is a bottom view of a pick with a double helicoidal shape in the tip and in the bottom.

FIG. 9 is a section view of a pick with a thickness that varies throughout the pick's length.

FIG. 10 is an exemplary illustration showing a front view of the twisted pick being held by a player's index and thumb, showing how the self-centering geometry fixes the pick's position between the fingers.

FIG. 11 is an exemplary illustration showing a side view of the twisted pick being held by a player's index and thumb, showing how the self-centering geometry fixes the pick's position between the fingers FIG. 12 is an exemplary illustration that shows a pick with a torsion only in the bottom engaging the strings, presenting a more flexibility for a longer attack.

FIG. 13 is an exemplary illustration that shows a pick with a torsion both in the bottom and in the tip engaging the strings, presenting more rigidity for a shorter attack.

### EXPLANATION OF A DETAILED EMBODIMENT OF THE INVENTION

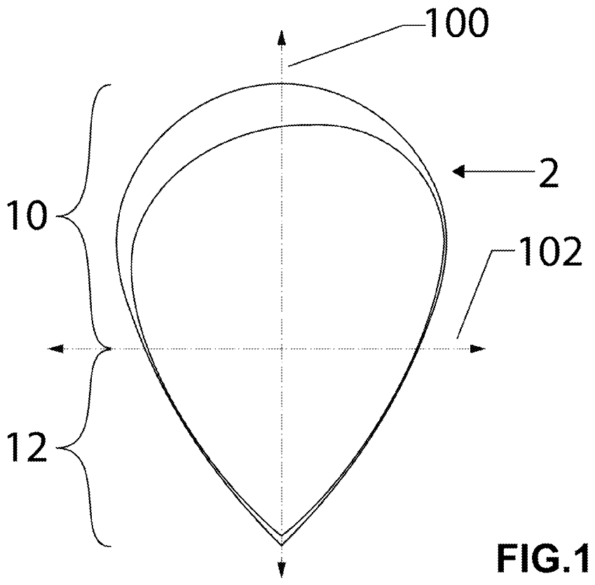

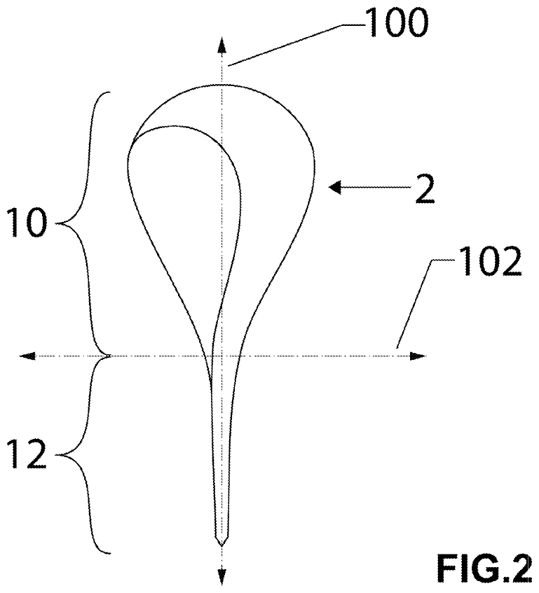

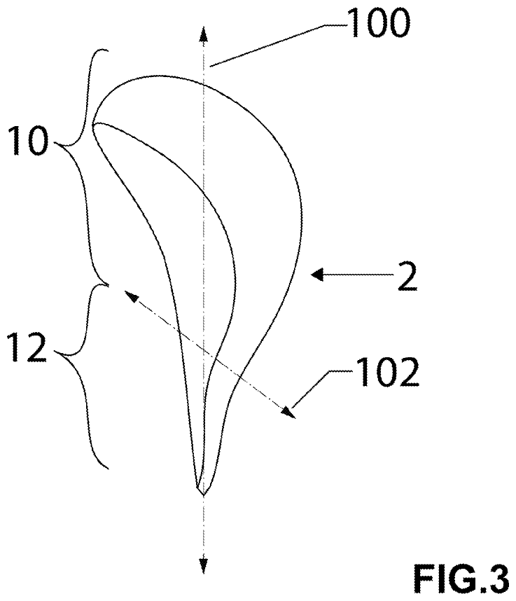

An example of an embodiment of the invention is shown in the attached figures. The FIGS. 1, 2 and 3 show a front view, side view and isometric view of a pick 2 that represents a possible embodiment of the present invention, with a parting line 102 that separates the double helicoidally shaped bottom part 10 from the flat tip part 12. The bottom part 10 has been given a double helicoidal shape that revolves around the pick's longitudinal axis 100 to center itself between the index and thumb of the player when held by the player.

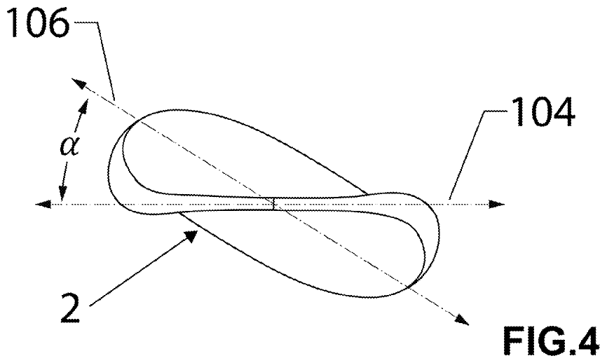

FIG. 4 shows a bottom view of the pick 2, where the angle “α” is formed by edge 104 of the pick's bottom's central double helix surface at the height of the parting line 102 and the edge 106 of the same central surface at the bottom end of the pick. Edges 104 and 106 of said central surface are both perpendicular to longitudinal axis 100.

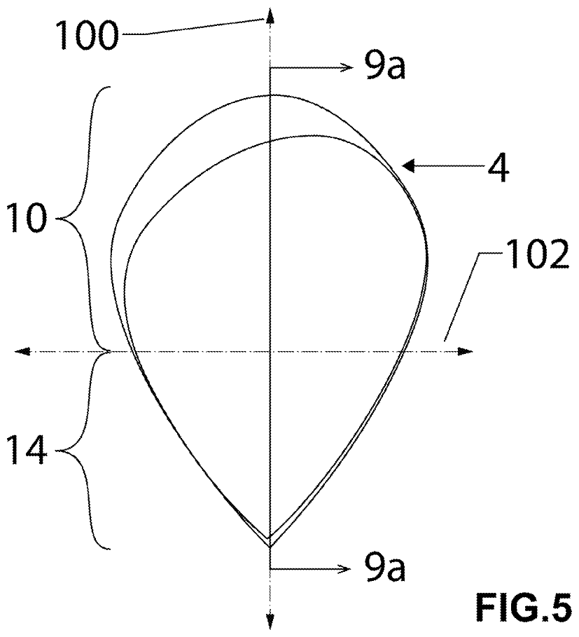

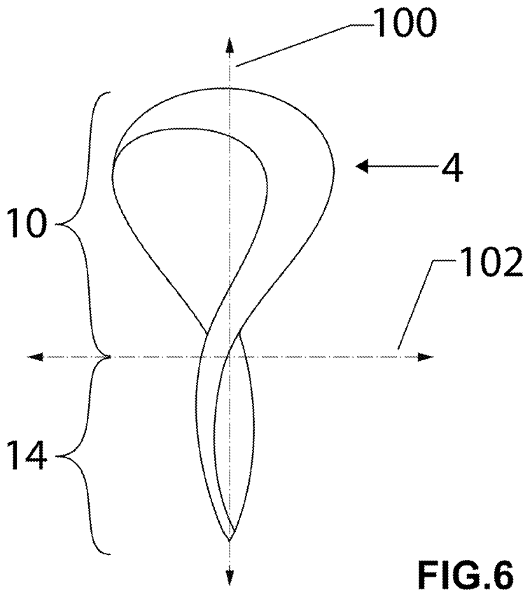

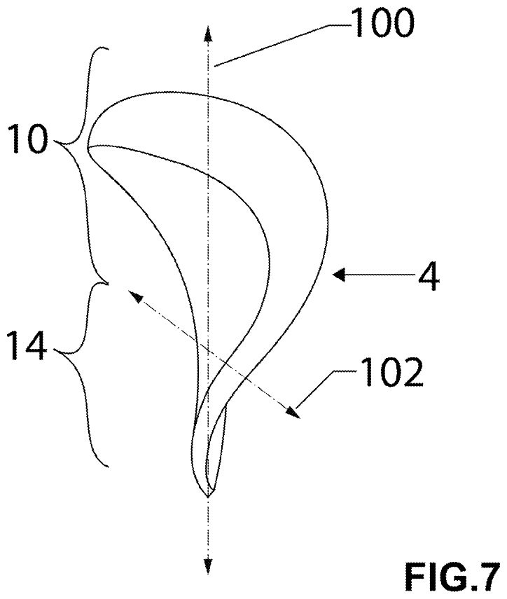

FIGS. 5, 6 and 7 show a front view, side view and isometric view of a pick 4 that represents another possible embodiment of the present invention, with a parting line 102 that separates the double helicoidally shaped bottom part 10 from the double helicoidally shaped tip part 14. Both the bottom part 10 and the tip part 14 have been given double helicoidal shapes that revolve around the pick's longitudinal axis 100 to center itself between the index and thumb of the player when held by the player, and which share an edge at the parting line 102.

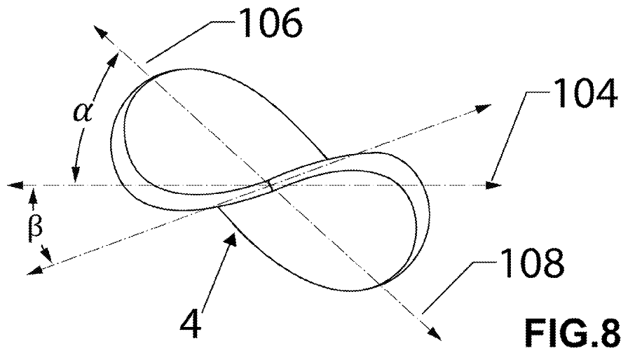

FIG. 8 shows a bottom view of the pick 4, where the angle “α” is formed by edge 104 of the pick's bottom's central double helicoidal surface at the height of the parting line 102 and the edge 106 of the pick's bottom's central double helicoidal surface at the bottom end of the pick, and where the angle “β” is formed by edge 104 of the pick's tip's central double helicoidal surface at the height of the parting line 102 and the edge 108 of the tip's central double helicoidal surface at the tip end of the pick. Edges 104,106 and 108 of said central surface are perpendicular to longitudinal axis 100.

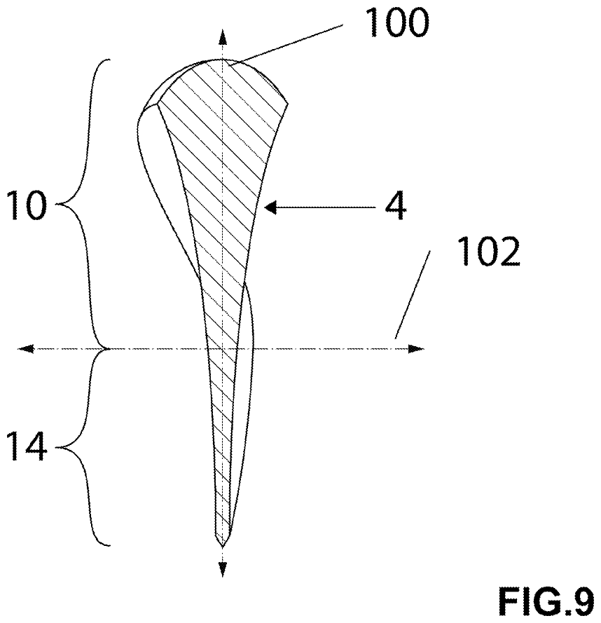

FIG. 9 shows a section view of pick 4, where its variable thickness and the effect of the different torsions of the bottom part 10 and the tip part 14 can be appreciated.

The parting line 102 may be located at different points of the pick's length, however, the length of the tip part 12 must be sufficient to engage the strings from below the parting line when the musician uses the pick, so a minimum distance of five millimeters between the end of the tip of the pick and the parting line is required. Likewise, a sufficient distance is necessary for bottom part 10 to be able to accommodate the player's fingers, for which bottom part 10's length must be of a minimum of twelve millimeters.

The value of angle “α” for the torsion of the bottom part's central double helicoidal surface in combination with the length of the bottom part 10 determines how the pick engages the player's fingers. While a variety of angles and lengths may be possible, and different combinations may be preferred by players with different finger sizes and playing styles, angle “α” must be within the range of five to ninety degrees. Likewise, the value of angle “β” for the torsion in the tip part's central double helicoidal surface in combination with the length of the tip part 12 or 14 determines how the pick engages the strings. The acceptable range of values for angle “β” is from zero to ninety degrees of torsion.

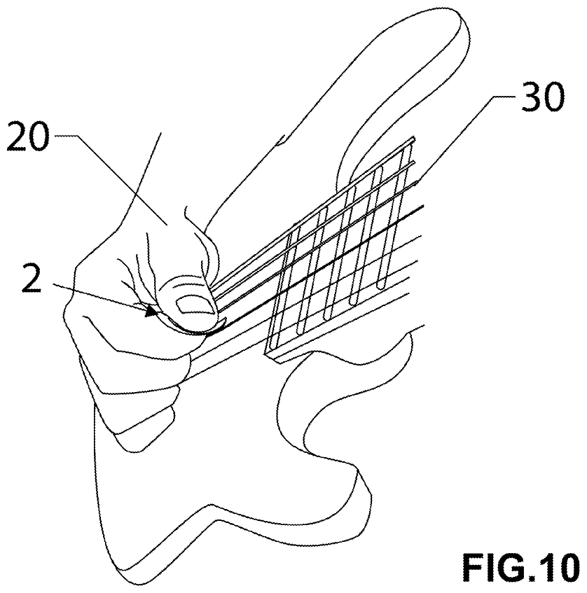

FIG. 10 shows an environmental view illustrating the pick 2 in use. The bottom part 10 of pick 2 is being held by the index and thumb of the player's hand 20, self-centering between these two fingers thanks to the torsion of angle “α” present on the bottom part 10. The tip end 12 is more flexible due to its flat shape that results of the tip 12 having an angle “β” equal to zero degrees, allowing it to bend more and create a longer attack when it is pressed against the strings 30.

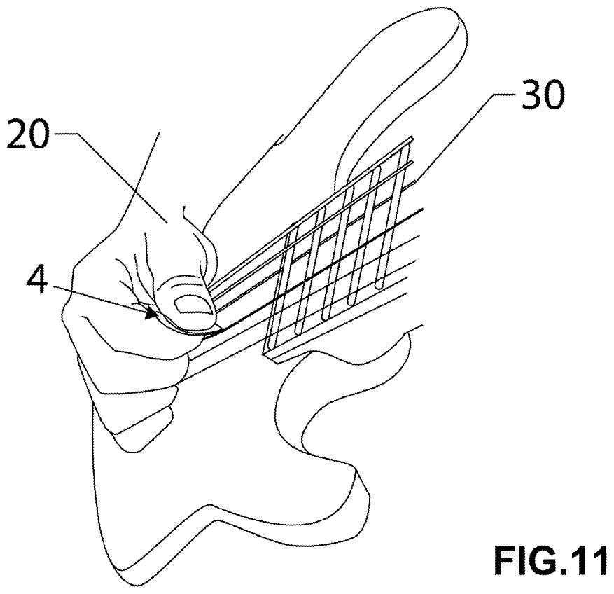

FIG. 11 shows an environmental view illustrating the pick 4 in use. The bottom part 10 of pick 2 is being held by the index and thumb of the player's hand 20, self-centering between these two fingers thanks to the torsion of angle “α” present on the bottom part 10. The tip end 14 is more rigid due to its double helicoidal shape that twists “β” degrees along the length of 14, allowing it to bend less and create a shorter attack when it is pressed against the strings 30.

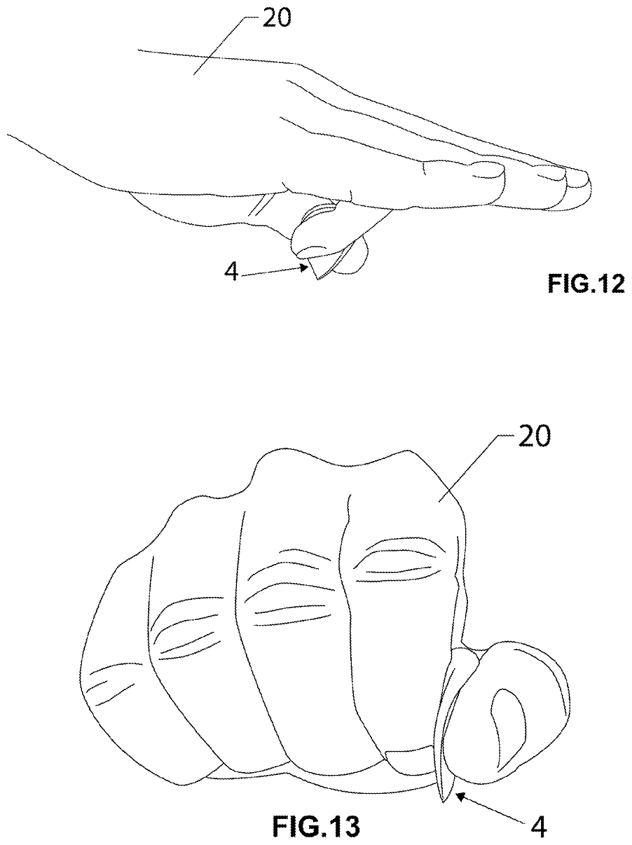

FIGS. 12 and 13 display a pick 4 being held by a musician's hand 20 from the side and from the front, illustrating how the self-centering geometry of the pick's bottom part 10 centers the pick between the index and the thumb of the player.

The benefits of introducing these additional variables (length of the pick's bottom part 10, length of the pick's tip part 12 or 14, angle of torsion “α” along the length of the bottom part 10 and, angle of torsion “β” along the length of the tip part 14) unique to inventive picks 2 and 4 include a great reduction to the necessary pressure that the musician needs to apply to the pick to hold it in the correct position while playing thanks to the self-centering properties of the bottom part's twist of angle “α”, while also offering more control over the attack of the pick due to the increased stiffness produced by the torsion with angle “β” that shapes the part of the pick that flexes as a consequence of pressing it against the strings.

The embodiments show herein are configured for a right-handed musician. If the direction of the torsions was inverted, it is to be understood that they would then be able to accommodate a left-handed musician as well.

Although two embodiments have been described in detail for the purposes of illustration (differing only in the angle “β” having an angle equal to or different from zero), various modifications may be made without departing from the scope and spirit of the invention, such as but not limited to the overall shape of the pick before being subject to the torsion, different values for its thickness or different shapes for its tip. Accordingly, the invention is not to be limited, except as by the appended claims.

1. A torsioned pick for playing stringed instruments that offers control over the attack of the played notes, comprising: a guitar pick body, where a bottom part that is held by a musician's fingers is twisted along the pick's longitudinal axis to create a double helicoidal geometry for the musician's index finger and thumb.

2. The pick of claim 1, where a part of the pick that engages the strings is flat.

3. The pick of claim 1, where a part of the pick that engages the string is twisted along the pick's longitudinal axis to create a double helicoidal geometry.
